(19) United States
(12) Patent Application Publication
(10) Pub. No.: US 2025/0061870 A1
(43) Pub. Date: Feb. 20, 2025

(54) METHOD FOR GENERATING MUSICAL SCORE, ELECTRONIC DEVICE, AND READABLE STORAGE MEDIUM

(71) Applicant: Tencent Music Entertainment Technology (Shenzhen) Co., Ltd., Shenzhen (CN)

(72) Inventors: Yuanqing Rui, Shenzhen (CN); Yiyong Jiang, Shenzhen (CN); Yulei Li, Shenzhen (CN)

(73) Assignee: Tencent Music Entertainment Technology (Shenzhen) Co., Ltd., Shenzhen (CN)

(21) Appl. No.: 18/691,428

(22) PCT Filed: May 25, 2022
(86) PCT No.: PCT/CN2022/094961

§ 371 Date: Mar. 12, 2024

(30) Foreign Application Priority Data
Sep. 16, 2021 (CN) 202111088919.7

(51) Int. Cl. G10H 1/38

(52) U.S. Cl. CPC G10H 1/383; G10H 2210/071; G10H 2210/076; G10H 2210/086; G10H 2220/015

(57) ABSTRACT

A method for generating a musical score, a device, and a computer-readable storage medium. The method includes: obtaining target audio; generating a chromagram of the target audio corresponding to each pitch class, utilizing the chromagram to identify a chord of the target audio, and obtaining chord information; performing mode detection on the target audio, and obtaining original key information; performing rhythm detection on the target audio and obtaining the beats per minute; performing identification on a beat type of each audio frame of the target audio, and determining an audio time signature on the basis of a correspondence relationship between a beat type and a time signature; utilizing the chord information, the original key information, the beats per minute, and the audio time signature and performing musical score rendering, and obtaining a target musical score.

This application claims priority to Chinese Patent Application No. 20211088919.7, titled “METHOD FOR GENERATING MUSICAL SCORE, ELECTRONIC DEVICE, AND READABLE STORAGE MEDIUM”, filed on Sep. 16, 2021 with the China National Intellectual Property Administration, which is incorporated herein by reference in its entirety.

### FIELD

The present disclosure relates to the technical field of audio processing, and in particular to a method for generating a music score, an electronic device for generating a music score and a computer readable storage medium.

### BACKGROUND

A music score, also known as sheet music, is a systematic arrangement of written symbols representing musical pitches or rhythms. Numbered musical notation, staff notation, guitar tabs, guqin scores, and other various modern or ancient forms of sheet music commonly used, are all referred to as music scores. Currently, music scores, in general, are generated through manual transcription, such as guitar tabs. This method is inefficient and often results in inaccuracies in the music scores.

### SUMMARY

In view of the above, an objective of the present disclosure is to provide a method for generating a music score, an electronic device for generating a music score and a computer-readable storage medium, which can generate an accurate music score efficiently.

In order to solve the above technical problems, in a first aspect, a method for generating a music score is provided according to the present disclosure, the method includes:
obtaining a target audio;
generating a chromagram of the target audio corresponding to each of pitch classes;
identifying chords of the target audio based on the chromagram, to obtain chord information;
detecting a mode of the target audio to obtain original mode information;
detecting a rhythm of the target audio to obtain a quantity of beats;
identifying a beat type of each of audio frames of the target audio;
determining a time signature of the target audio based on a correspondence relationship between a beat type and a time signature; and
performing music score rendering based on the chord information, the original mode information, the quantity of beats and the time signature of the target audio, to obtain a target music score.

In an embodiment, the process of performing music score rendering based on the chord information, the original mode information, the quantity of beats and the time signature of the target audio to obtain the target music score includes:
determining position information of each word of target lyrics in the target audio, where the target lyrics are lyrics corresponding to the target audio;
determining a note type of the each word based on a duration thereof; and
generating a first music score based on the chord information, the original mode information, the quantity of beats and the time signature of the target audio;
performing a marking processing on the first music score by using the target lyrics based on the position information and the note types, to obtain the target music score.

In an embodiment, the process of performing music score rendering based on the chord information, the original mode information, the quantity of beats and the time signature of the target audio to obtain the target music score includes:
determining fingering charts based on the chord information;
splicing the fingering charts based on the chord information, to obtain a second music score; and
performing a marking processing on the second music score by using the original mode information, the quantity of beats and the time signature of the target audio to obtain the target music score.

In an embodiment, the process of performing music score rendering based on the chord information, the original mode information, the quantity of beats and the time signature of the target audio to obtain the target music score includes:
modifying target information based on an obtained modification information for the music score to obtain modified information; where the target information is at least one of the original mode information, the chord information, a music score rendering rule and the quantity of beats; and
generating the target music score based on unmodified non-target information and the modified information.

In an embodiment, the detecting the mode of the target audio to obtain the original mode information includes:
extracting a note sequence of the target audio;
performing modulo calculations on the note sequence based on a plurality of different tonic parameters, to obtain a plurality of sequences of calculation results;
comparing each of the plurality of sequences of calculation results with major and minor sequences to obtain a quantity of matched notes; and
determining a mode corresponding to the major and minor sequences and the tonic parameter associated with a maximum quantity of matched notes as the original mode information.

In an embodiment, the detecting the rhythm of the target audio to obtain the quantity of beats includes:
calculating an energy value of each of audio frames in the target audio;
dividing the target audio into a plurality of intervals;
calculating an average energy value of each interval where the energy values belong to, based on the energy values;
determining that a beat is detected in a case that the energy value is greater than an energy value threshold; where, the energy value threshold is obtained from multiplying the average energy value by a weight value of each interval, and the weight value is obtained from a variance of the energy values of each interval; and
counting a quantity of beats per minute to obtain the quantity of beats.

In an embodiment, the detecting the rhythm of the target audio to obtain the quantity of beats includes:
generating a log-magnitude spectrum corresponding to the target audio;
inputting the log-magnitude spectrum into a trained neural network to obtain a probability value of each of audio frames in the target audio being a beat;
performing an autocorrelation calculation on a sequence of probability value formed by the probability values to obtain autocorrelation parameters; and
determining a maximum autocorrelation parameter within a preset range as the quantity of beats.

In an embodiment, the method further includes:
establishing an audio and music score correspondence relationship between the target audio and the target music score;
storing the target music score and the audio and music score correspondence relationship;
determining, in a case that a request for outputting a music score is detected, whether there is a request music score corresponding to the request for outputting the music score based on audio and music score correspondence relationships; and
outputting the request music score in a case that there is the request music score.

In an embodiment, the method further includes:
determining a beat audio based on a target quantity of beats in the target music score;
playing the beat audio after a start signal is detected, and counting a playing duration;
determining a target part in the target music score based on the target quantity of beats and the playing duration; and
performing a marking processing on the target part with a reminder note.

In a second aspect, an electronic device is provided according to the present disclosure, the electronic device includes a memory and a processor, where
the memory is configured to store a computer program; and
the processor is configured to execute the computer program to implement the above method for generating the music score.

In a third aspect, a computer readable storage medium is provided according to the present disclosure, storing a computer program. The computer program, when executed by a processor, implements the above method for generating the music score.

According to the method for generating the music score provided in the present disclosure, the target audio is obtained, the chromagram of the target audio corresponding to each of pitch classes is generated, and the chords of the target audio are identified based on the chromagram to obtain chord information. The mode of the target audio is detected to obtain the original mode information. The rhythm of the target audio is detected to obtain the quantity of beats. The beat type of each audio frame of the target audio is identified, and the time signature of the audio is determined based on the correspondence relationship between the beat type and the time signature. The chord information, the original mode information, the quantity of beats and the time signature of the audio are used to perform music score rendering to obtain the target music score.

According to the method, after the target audio is obtained, the energy distribution of the target audio in the frequency domain is represented by means of chromagrams, then the chords of the target audio are identified, and the chord information is obtained. Since a mode and a time signature are important basis for the play, they are required to be reflected in the music score, thus the original mode information is obtained by detecting the mode of the target audio. By identifying the beat types, the time signature is determined based on the combination of beat types. The quantity of beats (or beat per minute) can indicate a rhythm speed of an audio, the time of chords is determined by using the quantity of beats. After obtaining the above information, the chord information, the original mode information, the quantity of beats and the time signature of the audio are used to perform music score rendering to obtain the target music score. Through processing the target audio, the necessary data and information for performing music score rendering are obtained, and then the target music score is rendered based on the data and information. Compared with the manner of manual transcription, the accurate music score can be generated efficiently by using this method, the efficiency and accuracy of the music score generation are higher, thereby solving the problem of related technology with low efficiency and unsatisfied accuracy of music score.

In addition, an electronic device and a computer readable storage medium are further provided according to the present disclosure, which also have the above beneficial effects.

### BRIEF DESCRIPTION OF THE DRAWINGS

For clearer illustration of the technical solutions according to embodiments of the present disclosure or conventional techniques, hereinafter are briefly described the drawings to be applied in embodiments of the present disclosure or conventional techniques. Apparently, the drawings in the following descriptions are only some embodiments of the present disclosure, and those skilled in the art can obtain other drawings from these drawings without any creative effort.

FIG. 1 is a schematic diagram of a hardware composition framework applicable to a method for generating a music score according to an embodiment of the present disclosure;

FIG. 2 is a schematic diagram of a hardware composition framework applicable to a method for generating a music score according to another embodiment of the present disclosure;

FIG. 3 is a schematic flowchart of a method for generating a music score according to an embodiment of the present disclosure;

FIG. 4 is a chromagram according to an embodiment of the present disclosure;

FIG. 5 is a second music score according to a specific embodiment of the present disclosure;

FIG. 6 is a target music score according to a specific embodiment of the present disclosure; and

FIG. 7 illustrates fingering charts according to an embodiment of the present disclosure.

### DETAILED DESCRIPTION

For clearer illustration of the objective, technical solutions and advantages of the embodiments of the present disclosure, technical solutions in the embodiments of the present disclosure hereinafter are described clearly and thoroughly with reference to the drawings in the embodiments of the present disclosure. Apparently, the described embodiments are only some, rather than all of the embodiments of the present disclosure. Any other embodiments obtained by those skilled in the art based on the embodiments in the present disclosure without any creative effort fall within the protection scope of the present disclosure.

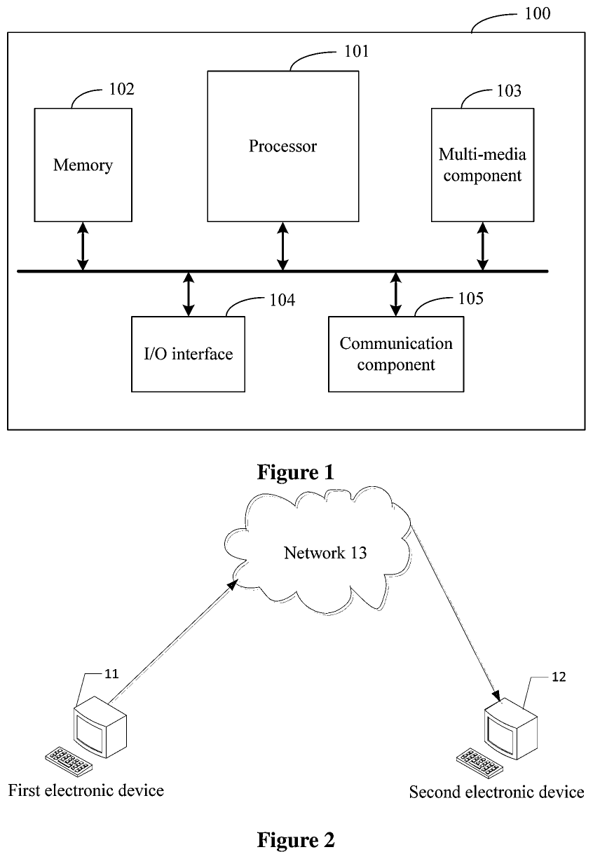

In order to facilitate understanding, the hardware composition framework used in the solutions corresponding to a method for generating a music score provided according to an embodiment of the present disclosure is firstly provided. Reference is made to FIG. 1. FIG. 1 is a schematic diagram of a hardware composition framework applicable to a method for generating a music score according to an embodiment of the present disclosure. Where, an electronic device 100 may include a processor 101 and a memory 102, and may further include one or more of a multi-media component 103, an information input/output (I/O) interface 104 and a communication component 105.

Where, the processor 101 is configured to control the overall operation of the electronic device 100, to implement all or part of the steps in the above method for generating the music score. The memory 102 is configured to store various types of data to support the operation of the electronic device 100. These data may include, for example, any application program or instructions of the method operating on the electronic device 100, and application program-related data. The memory 102 may be implemented by any type of volatile or non-volatile memory device or a combination thereof, for example, one or more of a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk. In an embodiment, the memory 102 stores at least program or/and data for implementing functions as follows:
obtaining a target audio;
generating a chromagram of the target audio corresponding to each of pitch classes;
identifying chords of the target audio based on the chromagram, to obtain chord information;
detecting a mode of the target audio to obtain original mode information;
detecting a rhythm of the target audio to obtain a quantity of beats;
identifying a beat type of each of audio frames of the target audio;
determining a time signature of the target audio based on a correspondence relationship between a beat type and a time signature; and
performing music score rendering based on the chord information, the original mode information, the quantity of beats and the time signature of the target audio to obtain a target music score.

The multi-media component 103 may include a screen and an audio component. The screen may be, for example, a touch screen, and the audio component is configured to output and/or input audio signals. For example, the audio component may include a microphone for receiving external audio signals. The received audio signals may be further stored in the memory 102 or sent through a communication component 105. The audio component further includes at least one speaker for outputting audio signals. The I/O interface 104 provides an interface between the processor 101 and other interface modules, the other interface modules described above may be a keyboard, a mouse, buttons, and the like. The buttons may be virtual buttons or entity buttons. The communication component 105 is configured to perform wired or wireless communication between the electronic device 100 and other devices. The wireless communication may be, such as Wi-Fi, Bluetooth, near field communication (NFC), 2G, 3G or 4G, or a combination of one or more thereof, therefore the corresponding communication component 105 may include a Wi-Fi component, a Bluetooth component, and an NFC component.

The electronic device 100 may be implemented by one or more of an application specific integrated circuit (ASIC), a digital signal processor (DSP), a digital signal processing device (DSPD), a programmable logic device (PLD), a field programmable gate array (FPGA), a controller, a microcontroller, a microprocessor or other electronic components, which is configured to implement the method for generating the music score.

Apparently, the structure of the electronic device 100 shown in FIG. 1 does not constitute a limitation on the electronic device provided in the embodiments of the present disclosure. In practical applications, the electronic device 100 may include more or fewer components than components shown in FIG. 1, or a combination of some components.

It should be understood that the quantity of electronic devices in the embodiment of the present disclosure is not limited, and the method for generating the music score may be implemented by cooperation of multiple electronic devices. In an embodiment, reference is made to FIG. 2. FIG. 2 is a schematic diagram of a hardware composition framework applicable to a method for generating a music score according to another embodiment of the present disclosure. As shown in FIG. 2, the hardware composition framework may include a first electronic device 11 and a second electronic device 12, where the first electronic device 11 and the second electronic device 12 are connected through a network 13.

In an embodiment, hardware structures of the first electronic device 11 and the second electronic device 12 may refer to the electronic device 100 in FIG. 1. It can be understood that there are two electronic devices 100 in this embodiment, where the two electronic devices perform data interaction with each other. Further, a form of the network 13 is not limited in the embodiment of the present disclosure, for example, the network 13 may be a wireless network (such as WIFI, Bluetooth), or a wired network.

Where, the first electronic device 11 and the second electronic device 12 may be the same electronic device. For example, the first electronic device 11 and the second electronic device 12 are servers. The first electronic device 11 and the second electronic device 12 may be different types of electronic devices. For example, the first electronic device 11 may be a smart phone or other intelligent terminals, and the second electronic device 12 may be a server. In an embodiment, a server with high computing ability may be configured as a secondary electronic device 12 to improve the efficiency and reliability of data processing, and thereby improving the processing efficiency of generating a music score. In addition, a smart phone with low cost and wide application range is configured as the first electronic device 11 to implement the interaction between the second electronic device 12 and users. It can be understood that the interaction process may be as follows. The smartphone obtains the target audio and sends the target audio to the server, and the server generates the target music score. The server sends the target music score to the smartphone, and the smartphone displays the target music score.

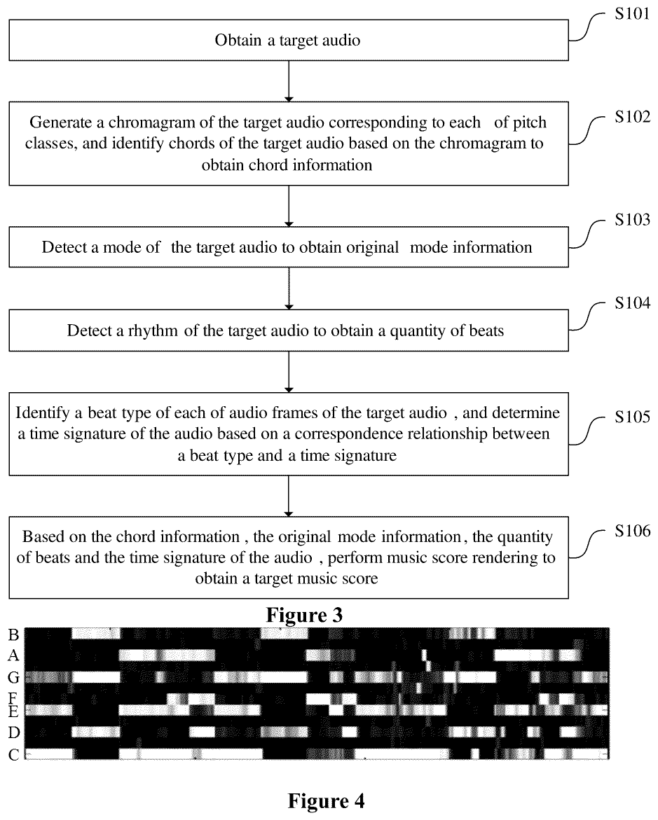

Based on the above description, reference is made to FIG. 3. FIG. 3 is a schematic flowchart of a method for generating a music score according to an embodiment of the present disclosure. The method in the embodiment includes steps S101 to S106 as follows.

In step S101, a target audio is obtained.

The target audio refers to an audio that requires the generation of a corresponding music score, the quantity and type of the target audio are not limited. In an embodiment, the target audio may be a song with lyrics, or may be pure music without lyrics. A specific obtainment mode of the target audio is not limited. For example, the audio information may first be obtained and used to filter local pre-stored audios to obtain the target audio. Alternatively, the target audio inputted from exterior is obtained through the data transmission interface.

In step S102, a chromagram of the target audio corresponding to each pitch class is generated, and chords of the target audio are identified based on the chromagram to obtain chord information.

Chromagram, chroma feature is a general term of a chroma vector and a chromagram. The chroma vector is a vector including twelve elements, which respectively represent energy of twelve pitch classes in a period of time (such as one frame), and the energy of the same pitch class in different octaves are added up. The chromagram is a sequence of chroma vectors. Take a piano as an example, eighty-eight pitches can be played by the piano, which appear periodically as seven white key notes, i.e., do, re, mi, fa, so, la, ti (and the five black keys in between). The do in a set and the do in a next set are an octave relationship. The twelve notes construct the twelve pitch classes if the concept between sets is ignored.

The chromagram is usually generated from constant-Q transform (CQT). In an embodiment, the target audio is transformed from a time domain to a frequency domain from Fourier transform, and frequency domain signals are de-noised and then tuned to achieve a similar effect of “tuning different pianos to a standard frequency”. The absolute time is then converted into frames according to the length of a selected window, and energy of each pitch within each frame is recorded to form a pitch map. Based on the pitch map, energy of notes at the same time, at the same pitch, and at different octaves is superposed on elements of the pitch class within the chroma vector to form a chromagram. Reference is made to FIG. 4. FIG. 4 is a chromagram according to an embodiment of the present disclosure. In a first major grid, three pitch classes C, E and G are extremely bright. According to music theory knowledge, it can be determined that a major chord of C major (Cmaj), or named C major triad, is played during this period of the target audio.

Chord is a concept in music theory, which refers to a set of sounds with a certain interval relation. Three or more notes, in accordance with the superposition of third or non-third, are combined longitudinally to constitute a chord. Interval refers to a relationship between two pitch classes in pitch, that is, a distance between two notes in pitch, a unit name of the interval is degree. Based on the above described chromagram and the music theory knowledge, corresponding chords of the target audio at different times are determined and the chord information is obtained.

In step S103, the mode of the target audio is detected to obtain original mode information.

The mode refers to an organism formed by a core of a note and several of musical notes organized by different pitches according to a certain interval relationship. Modes are specifically divided into major and minor, which follow different interval relationships.

In an embodiment, the interval relationship between the notes in a major scale follows a pattern of whole-whole-half-whole-whole-whole-half, with the intervallic relationships between the notes being 0-2-4-5-7-9-11-12. Here, the distance from the first note to the second note is 2, which is a whole step; the distance from the second note to the third note is 2, also a whole step; the distance from the third note to the fourth note is 1, which is a half step, and so on. The interval relationship between the notes in a minor scale follows a pattern of whole-half-whole-whole-half-whole-whole, with the intervallic relationships between the notes being 0-2-3-5-7-8-10-12. When several notes in a mode are arranged into a scale, a tonic is a core of the mode, and the most stable note in the mode is the tonic. Since there are twelve scales, each of the twelve scales may be used as the tonic, specifically includes C, C#(or Db), D, D#(or Eb), E, F, F#(or Gb), G, G#(or Ab), A, A#(or Bb), or B. Where # indicates a sharp, which is a half note higher than the original note, and b indicates a flat, which is a half note lower the original note. Since modes are divided into major and minor, there are twenty-four modes in total.

The specific approach of mode detection is not limited in this embodiment. In an embodiment, the target audio may be inputted into a trained convolutional neural network, which is trained by using a large number of training data with marked modes. The specific structure of the convolutional neural network may be a multi-layer convolutional neural network structure. After the target audio is inputted into the convolutional neural network, it may select, among the 24 mode categories, a mode with the highest probability as the mode of the target audio. In another embodiment, the note sequence may be subjected to modulo calculation and matched with major and minor scale patterns. The original mode information is obtained based on the matching results.

In step S104, a rhythm of the target audio is detected to obtain a quantity of beats.

BPM is an abbreviation of Beat Per Minute, also referred to as the quantity of beats, which is interpreted as a unit of the quantity of beats per minute. BPM is the speed mark of the whole song, which is a speed standard independent of the music score. Generally, a quarter note is taken as a beat, and 60 BPM indicates sixty quarter notes (or equivalent note combination) played in one minute. Rhythm detection is BPM detection, the quantity of beats is used to control the playing speed of the audio, and the same chord is played at different rhythms under different BPMs.

The specific approach of rhythm detection is not limited in this embodiment. In an embodiment, an autocorrelation calculation may be performed based on the probability sequence that each audio frame of the target audio is a beat, and the calculated result is determined as BPM. In another embodiment, beats may be detected based on the energy distribution of each audio frame over a period of time to determine BPM based on the detected beats.

In step S105, a beat type of each audio frame of the target audio is identified, and the time signature of the audio is determined based on a correspondence relationship between a beat type and a time signature.

The time signature is a symbol used in music score and marked in a form of a fraction. Each music score has a time signature in a front of the music score. In a case that the rhythm is changed in the midway, the changed time signature is marked. The time signature is a fraction, such as 2/4, ¾, etc. The denominator of the fraction indicates the note value of a beat, i.e., the note value represents one beat. For example, in 2/4, where the quarter note represents one beat, and each measure contains two beats. The numerator indicates the quantity of beats in each measure. For example, 2/4 time signature indicates that a quarter note is taken a beat, and each measure has two beats; while ¾ indicates that a quarter note is taken as a beat, and each measure has three beats, and so on. In music, rhythm is an indispensable element, which is a series of organized relationships between long and short durations. The relationship of durations are required to be standardized using time signatures. The role of the time signature is to divide the multitude of notes by rules, making the rhythm distinct. For example, in 4/4 and ¾ time signatures, the distribution of beats in each measure of 4/4 time signature is down beat, beat, secondary down beat, and secondary weak beat; while in ¾ time, it is down beat, beat, beat.

Given that the beat distributions of the downbeat and the beat may be detected to distinguish them, the beat that each frame belongs to may be divided in a non-beat, a downbeat and a beat. Such classification problem may be solved by a convolutional neural network or a recurrent neural network. The activation probability of three different beats in each frame can be detected, and the distribution of the downbeats and the beats can be determined through post-processing.

Therefore, the time signature may be identified in an opposite manner. Since the rhythm is related to intensity and distribution of beat, the beat type of each audio frame in the target audio may be identified. For example, the convolutional neural network or the recurrent neural network may be used to classify each audio frame and determine each audio frame as a non-beat, a downbeat or a beat. Based on the intensity and distribution of the beat, the corresponding time signature of the target audio is determined based on the correspondence relationship between a beat type and a time signature. It should be noted that the above beat type detection method is only a specific implementation, and other methods may further be used to detect the beat.

In step S106, based on the chord information, the original mode information, the quantity of beats and the time signature of the audio, the music score rendering is performed, to obtain a target music score.

It should be noted that a specific execution order of the four steps S102, S103, S104 and S105 is not limited, which may be executed in parallel or serial. After obtaining the chord information, the original mode information, the quantity of beats and the time signature of the audio required by the music score, the music score rendering may be performed based on the chord information, the original mode information, the quantity of beats and the time signature of the audio to obtain a target music score corresponding to the target audio. In an embodiment, music score rendering may be performed based on preset rendering rules. There are multiple rendering rules, and each of the multiple rendering rules is related to the music score type of the target music score, such as guitar score, or piano score, etc. In an embodiment, a music score rendering rule is a corresponding relationship between a chord and a pre-stored fingering charts. According to the above information, the corresponding fingering charts may be selected and spliced to obtain the target music score. In another embodiment, the music score rendering rules are music score rendering rules set according to music theory knowledge. For example, a first beat of C chord has two notes, which are fifth string and third string respectively, and a second beat has two notes, which are second string and third string respectively. Then the corresponding music score rendering rules may be rendered as a data form, such as C (1:5, 2; 2, 3).

According to the method for generating the music score provided in an embodiment of the present disclosure, after the target audio is obtained, the energy distribution of the target audio in the frequency domain is represented in the form of the chromagram, then the chords of the target audio are identified, and the chord information is obtained. Since a mode and a time signature are important basis for the play, which is required be reflected in the music score, the original mode information is obtained by performing mode detection on the target audio. By performing identification on the beat type, the time signature of the audio is determined based on the combination of beat types. The quantity of beats (or beat per minute) can indicate the speed of the rhythm of the audio, the time corresponding to the chord is determined by using the quantity of beats. After obtaining the above information, the chord information, the original mode information, the quantity of beats and the time signature of the audio are used to perform music score rendering to obtain the target music score. Through processing the target audio, the necessary data and information for performing music score rendering are obtained, and then the target music score is rendered based on the data and information. Compared with the manual transcription manner, the accurate music score can be generated efficiently using the provided method, the efficiency and accuracy of the music score generation are higher, thereby solving the problem of related technology with low efficiency and unsatisfied accuracy of music score.

Based on the above embodiment, this embodiment specifies some of the steps in the above embodiment. In an embodiment, in order to obtain accurate original mode information, mode detection is performed on the target audio. The process of obtaining the original mode information may include steps 11 to 14 as follows.

In step 11, a note sequence of the target audio is extracted.

In step 12, a modulo calculation is performed on the note sequence based on multiple different tonic parameters, to obtain multiple sequences of calculation results.

In step 13, each of the multiple sequences of calculation results is compared with the major and minor sequences to obtain a corresponding quantity of matched notes.

In step 14, a mode corresponding to the major and minor sequences and the tonic parameter associated with the maximum quantity of matched notes is determined as the original mode information.

The note sequence refers to the notes corresponding to each audio frame in the target audio, which may be represented by note_array. Each value in the note sequence, namely note_array[i], is an integer. The tonic parameter refers to the parameter used to represent the tonic of the target audio. Since the tonic has twelve possibilities, there are twelve tonic parameters in total, which may be set to be twelve integers from 0 to 11. The tonic parameters may be represented by shift. Through the modulo calculation, the sequence of calculation results may be obtained. By selecting different tonic parameters, the obtained sequence of calculation results can represent a mode of the target audio under a condition that the note represented by the tonic parameter is a tonic.

In an embodiment, the modulo calculation is a calculation of (note_array[i]+shift) % 12, where % represents modulo. Through modulo calculation, twelve sequences of calculation results may be obtained. The major and minor sequences may be a major sequence or a minor sequence. Where, the major sequence is (0 2 4 5 7 9 11 12), and the minor sequence is (0 2 3 5 7 8 10 12). In a case that all parameters in the sequence of calculation results fall into the major sequence and the tonic parameter is zero, it indicates that the mode of the target audio is C major. In fact, it is almost impossible for all parameters in the sequence of the calculation results to fall into the major sequence or minor sequence. In this case, the quantity of notes falling into the major sequence and the quantity of notes falling into the minor sequence in the sequence of calculation results may be counted, i.e., the quantity of corresponding matched notes may be obtained by comparing each of the sequences of the calculation results with the major and minor sequences respectively.

In an embodiment, in a case that the sequence of calculation results is ( . . . 0 5 7 . . . ), since the three parameters 0, 5 and 7 fall into both major sequence and minor sequence, i.e., the three parameters match with both major sequence and minor sequence, 3 is added to the quantity of matched notes corresponding to the major sequence, and 3 is added to the quantity of matched notes corresponding to the minor sequence. In a case that the sequence of calculation results is ( . . . 4, 9, 11), then the three parameters 4, 9 and 11 only fall into the major sequence, 3 is added to the quantity of matched notes corresponding to the major sequence. It should be understood that since there are twelve sequences of the calculation results corresponding to different tonic parameters, and each of the sequences of the calculation results has two quantities of matched note corresponding to the major sequence and the minor sequence respectively. Therefore, there are a total of twenty-four quantities of matched notes, corresponding to 24 types of modes. After obtaining twenty-four quantities of matched notes, the maximum value, i.e., the maximum quantity of matched notes, is selected from the twenty-four quantities of matched notes. Then, based on its corresponding major and minor sequences as well as the tonic parameter, a corresponding mode is determined.

Further, in an embodiment, for the rhythm detection process, in order to improve the accuracy of detecting the quantity of beats, rhythm detection is performed on the target audio, the process of obtaining the quantity of beats may include steps 21 to 24 as follows.

In step 21, the energy value of each audio frame in the target audio is calculated.

In step 22, the target audio is divided into multiple intervals; and based on the energy values, an average energy value of the interval where the respective energy values belong to is calculated.

In step 23, in a case that the energy value is greater than an energy value threshold, it is determined that a beat is detected.

In step 24, the quantity of beat per minute is counted to obtain the quantity of beats.

The energy value threshold is obtained from multiplying the average energy value by a weight value of the interval, and the weight value is obtained based on a variance of the energy values of each interval. The sampling rate to audio is relatively high, and sometimes may reaches 44100 Hz. The audio frames are usually divided by 1024 sampling points per frame. Therefore, on the premise that a sampling rate of 44100 Hz, one second of target audio may be divided into forty-three audio frames. The energy value corresponding to the audio frame may be calculated from

$${E}_{j} = {\sum }_{i = 0}^{1023} {input ( i )}^{2}$$

where, Eⱼ is an energy value of the audio frame of a sequence number j, input(i) is a sample value of each of the sampling points, and i is the sequence number of each sampling points in the current audio frame.

As the quantity of beats is BPM, it is required to count the quantity of beats per second. In this embodiment, the target audio is divided into multiple intervals, which may be the evenly division or non-evenly division, so as to determine an average energy value in each interval. The average energy value is used to determine the energy value threshold in this interval, and the energy value threshold is used to determine whether there is a beat recorded in a certain audio frame. In general, the intervals are evenly divided, where the time length of each interval is one second. Then the average energy value is calculated from

$$a v g ( E ) = \frac{1}{43} {\sum }_{j = 0}^{42} {E}_{j}$$

where, avg (E) is the average energy value. After the average energy value is obtained, an energy value threshold is obtained based on the average energy value and the weight value. In an embodiment, the weight value is calculated from

$$C = - 0.0 \; 000015 \cdot var ( E ) + 1.51 \; 42857$$

$$var ( E ) = \frac{1}{43} {\sum }_{j = 0}^{42} {( a ν g ( E ) - {E}_{j} )}^{2}$$

where, C is the weight value, var (E) is a variance of the energy value of the interval, and the energy value threshold is C*avg (E). In a case that the energy value of an audio frame in the interval is greater than the energy value threshold, it indicates that the audio frame with the energy value recorded a beat. The quantity of beats can be obtained by counting the quantity of beats per minute. In an embodiment, the quantity of beats per minute in each interval may be counted respectively to obtain multiple candidate quantities of beats, and the maximum one among the multiple candidate quantities of beats is determined as the quantity of beats. Alternatively, the quantity of beats of the entire target audio may be calculated, and the quantity of beats may be calculated by using the calculated quantity of beats and the time length of the target audio.

In an embodiment, rhythm detection may further be performed by using deep learning. The rhythm of the target audio is detected to obtain the quantity of beats, which includes steps 31 to 34 as follows.

In step 31, a log-magnitude spectrum corresponding to the target audio is generated.

In step 32, the log-magnitude spectrum is inputted into a trained neural network to obtain a probability value of each of audio frames in the target audio being a beat.

In step 33, an autocorrelation calculation is performed on a sequence of probability value formed by the probability values to obtain multiple autocorrelation parameters.

In step 34, a maximum autocorrelation parameter within a preset range is determined as the quantity of beats.

The log-magnitude spectrum is one of spectrograms, in which amplitude of each spectrum line is logarithmically calculated from the original amplitude A, the unit of vertical coordinates of the log-magnitude spectrum is in dB (decibel). The purpose of the logarithmic transformation is to pull the lower amplitude components up relative to the higher amplitude components, which facilitates the observation of the periodic signal masked in a low amplitude noise. The trained neural network is used to predict whether each audio frame in the target audio has recorded beat(s). After the log amplitude spectrum is inputted into the neural network, the neural network outputs the probability value of the beat(s) recorded in each audio frame, and the autocorrelation calculation is performed on the sequence of the probability value formed by the probability values. After the autocorrelation calculation is performed, more than one autocorrelation parameter is usually obtained. Since the BPM of audio is usually in a fixed interval, i.e., a preset range, the quantity of beats may be determined within the preset range. In an embodiment, a maximum autocorrelation parameter within the preset range is determined as the quantity of beats.

Further, in an embodiment, the target music score is a guitar score. In order to improve the speed of rendering the target music score, multiple candidate fingering charts may be pre-stored. The target music score is generated by selecting and splicing the existed fingering charts. In an embodiment, the process of performing music score rendering based on the chord information, the original mode information, the quantity of beats and the time signature of the audio to obtain the target music score may include steps 41 to 43 as follows.

In step 41, the fingering charts are determined by using the chord information.

In step 42, the fingering charts are spliced based on the chord information to obtain a second music score.

In step 43, the second music score is performed a marking processing by using the original mode information, the quantity of beats and the time signature of the audio, to obtain the target music score.

Where, the candidate fingering charts refer to the charts used to reflect a way that fingers control the strings when playing the guitar. The fingering charts refer to the candidate fingering charts corresponding to the chord information. It should be understood that, different chords require different fingerings to control the strings to play. Therefore, when the chord information is determined, a corresponding playing mode must have been determined, thereby determining the fingering charts. It should be noted that, in general, the same chord in different modes is played in different manners, thus, the chord information and the original mode information are used to jointly determine the fingering charts. Since chords are changeable and a fingering chart can only correspond to one tone or a small number of tones, there must be multiple fingering charts determined based on the chord information.

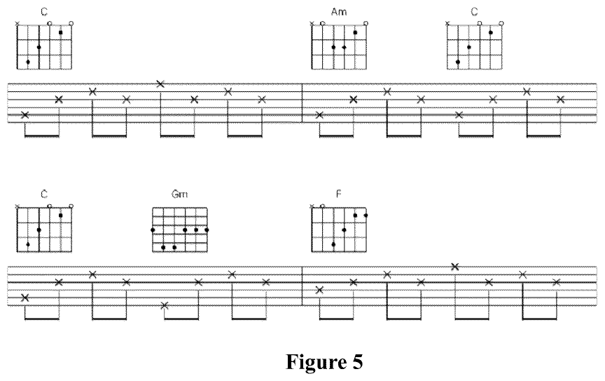

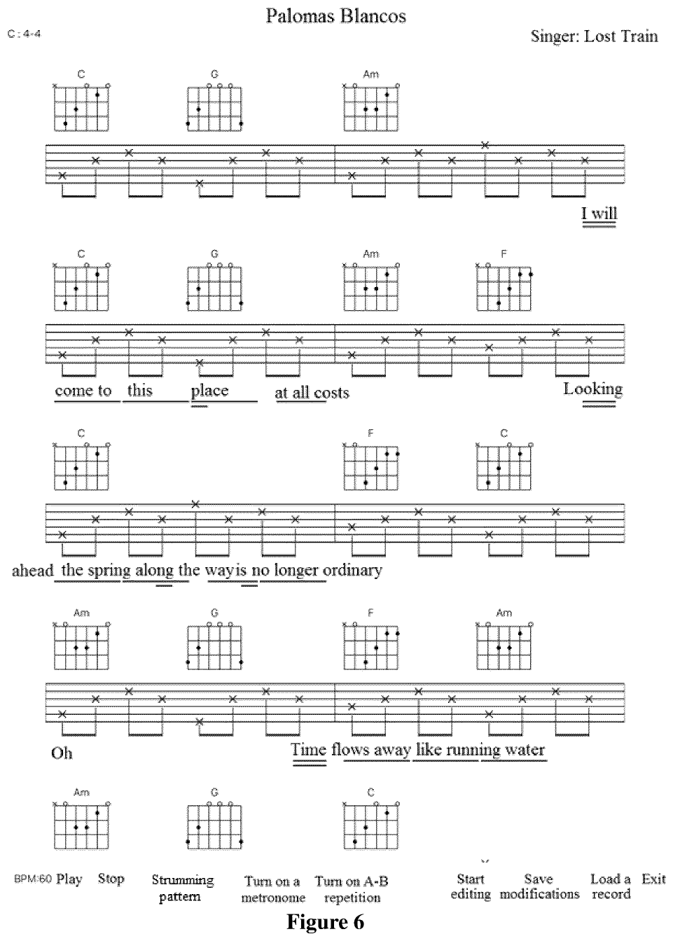

After obtaining the fingering charts, a second music score may be obtained by splicing each of the fingering charts, and the second music score is a music score obtained by splicing the fingering charts. It should be noted that the fingering charts include the charts of pressing strings and the charts of controlling strings. Where, the controlling strings include playing techniques such as plucking and strumming. Reference is made to FIG. 5. FIG. 5 illustrates a second music score according to a specific embodiment of the present disclosure. After a second music score is obtained, the target music score may be obtained by marking the second music score with the original mode information, the quantity of beats and the time signature of the audio. Reference is made to FIG. 6, FIG. 5 illustrates a target music score according to a specific embodiment of the present disclosure, where an original mode is C key, the quantity of beats is 60, and the time signature is 4/4.

In an embodiment, the target audio may be an audio with lyrics. In this case, the target music score may be set with markers corresponding to the lyrics. For example, the target music score as shown in FIG. 6 further includes lyrics. In an embodiment, the process of performing music score rendering based on the chord information, the original mode information, the quantity of beats and the time signature of the audio to obtain the target music score may include steps 51 to 53 as follows.

In step 51, position information of each word of the target lyrics in the target audio is determined.

In step 52, a corresponding note type is determined based on duration of each word.

In step 53, the first music score is generated based on the chord information, the original mode information, the quantity of beats and the time signature of the audio. And then, the first music score is performed a marking processing by using the target lyrics based on the position information and the note types to obtain the target music score.

In the embodiment, the first music score generated based on the chord information, the original mode information, the quantity of beats and time signature of the audio, which can be obtained in steps 41 to 43. Target lyrics are lyrics corresponding to the target audio. After obtaining the target lyrics, it is required to determine the position information of each word in the target audio. In an embodiment, the position information includes a timestamp. For example, the word-by-word lyric information corresponding to the song “Breeze of Spring for Ten Miles” is:

<LyricLine LineStartTime=“23036” LineDuration=“5520”>
<LyricWord word=“I” startTime=“23036” duration=“216”/>
<LyricWord word=“am” startTime=“23252” duration=“553”/>
<LyricWord word=“thinking” startTime=“23805” duration=“240”/>
<LyricWord word=“of” startTime=“24045” duration=“279”/>
<LyricWord word=“you” startTime=“24324” duration=“552”/>
<LyricWord word=“inside” startTime=“24876” duration=“281”/>
<LyricWord word=“of” startTime=“25157” duration=“199”/>
<LyricWord word=“the” startTime=“25356” duration=“872”/>
<LyricWord word=“second ” startTime=“26228” duration=“952”/>
<LyricWord word=“ring” startTime=“27180” duration=“320”/>
<LyricWord word=“road” startTime=“27500” duration=“1056”/>
</LyricLine>

where, startTime is a timestamp, duration is the duration of time.

In another embodiment, the position information may be a measure where each word is located and on which beat of the measure. In this case, the position information is required to be calculated by using the above timestamps:

```
  located measure = start time of the word (i.e., timestamp)/duration of a measure;
  position in the measure = (start time of a word − located measure *duration of the
measure)/(60/BPM).
```

After obtaining the position information, which may be used to determine the position of each word of the target lyrics in the first music score. Since each word has a different duration, the corresponding type of note of each word is different, such as sixteenth note, eighth note, or quarter note. In order to mark the playing manner of each word in the target music score, the corresponding note type is determined based on the duration. The note type and location information are determined and used as a basis, the first music score is marked by using the target lyrics, thereby obtaining the target music score.

Further, since a player usually cannot play the music with the chord, mode, playing manner and a playing speed, some information of the original music may be modified according to the requirements while generating the target music score, so that the generated target music score can meet the requirements of the user. Therefore, the performing music score rendering based on the chord information, the original mode information, the quantity of beats and the time signature of the audio to obtain the target music score may include steps 61 and 62 as follows.

In step 61, based on an obtained music score modification information, target information is modified.

In step 62, based on an unmodified non-target information and the modified information, the target music score is generated.

Where, the target information is at least one of the original mode information, the chord information, the music score rendering rule(s) and the quantity of beats. The non-target information is information other than the selected target information that is being modified. The music score modification information is used to modify specified target information. The quantity of beats may directly determine the playing speed of the audio. Modifying the quantity of beats can make the playing speed faster or slower than the playing speed of the target audio. The change of mode is also referred to as modulation, which is limited by the range of guitar mode choices that the user can master. For example, since beginners usually can only play the C key, the original music mode may be converted into a mode selected by the user. In other words, the original mode information is modified, for example, the G key is modified to the C key. It should also be noted that according to the music theory, the modification of mode usually leads to the modification of chords, i.e., the chords corresponding to each beat in the original music score need to be converted into the chords corresponding to the selected mode. For example, when the mode is modified from the G key to the C key, a first chord G in G key is converted into a first chord C corresponding to C key. Apparently, chords may also be modified individually according to requirements.

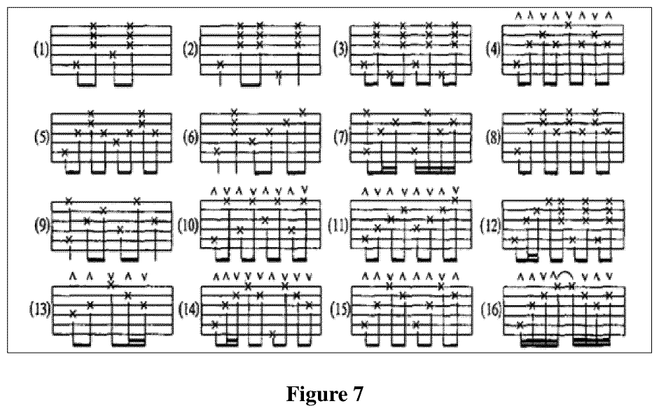

According to the modification of the music score rendering rules, information such as playing style of the music score may be modified. In an embodiment, in a case that the target music score is generated by splicing fingering charts, the music score rendering rules are a correspondence relationship between a chord and fingering (and the corresponding fingering chart). In guitar playing, playing may be performed by plucking or strumming strings, so the fingering charts corresponding to the same chord may be decomposed chord charts or rhythmic pattern charts. According to the music theory, different time signatures correspond to a series of different decomposed chords and rhythmic patterns. Reference is made to FIG. 7. FIG. 7 illustrates fingering charts according to an embodiment of the present disclosure, in which several rhythmic patterns corresponding to the common 4/4 time signature are recorded.

Furthermore, in order to eliminate the waste of computational resources, the music score may be stored for reuse after being generated. In an embodiment, the method includes steps 71 to 73 as follows.

In step 71, an audio and music score correspondence relationship between the target audio and the target music score is established, and the target music score and the audio and music score correspondence relationship is stored.

In step 72, in a case that a request for outputting a music score is detected, whether there is a request music score corresponding to the request for outputting the music score is determined based on the audio and music score correspondence relationships.

In step 73, in a case that there is the request music score, the request music score is outputted.

In a case that there is no request music score corresponding to the request for outputting the music score, the request music score is generated according to the method for generating the music score provided in the present disclosure, and the request music score is outputted. The specific storage form of music score is not limited. For example, in an embodiment, data such as the chord of each beat, the corresponding lyrics, and the note type of the lyrics may be recorded and saved. The content of the record may be as follows:

<BeatInfo chord=“G” segment=“9” beat=“1”>
<LyricInfo>
<LyricWord word=“bring” startPos=“2” note=“16”/>
<LyricWord word=“out” startPos=“3” note=“16”/>
<LyricWord word=“warmness” startPos=“4” note=“16””/>
</LyricInfo>
</BeatInfo>

The above indicates that: a corresponding chord of the first beat of the ninth measure is the G chord, the corresponding lyrics have three words, a first word of the three words “bring” is a sixteenth note, in a lyrics area under the six-line spectrum, the corresponding position is the second one, and so on.

In addition, the user is guided to play after the music score is generated or outputted, in an embodiment, including steps 81 to 83 as follows.

In step 81, a beat audio is determined based on a target quantity of beats in the target music score.

In step 82, upon a start signal is detected, the beat audio is played and playing duration is counted.

In step 83, a target part in the target music score is determined based on the target quantity of beats and the playing duration, and the target part is performed a marking processing with a reminder note.

Beat audio refers to an audio with regular beat reminder. The time interval of two adjacent beat notes in different beat audios is different. The target quantity of beats may be the unmodified quantity of beats, or the modified quantity of beats. Using the target quantity of beats, a value of the time interval of two adjacent beat notes may be determined, and then the beat audio is determined. In an embodiment, the time interval between two adjacent beat notes is (60/the target quantity of beats) seconds.

Once the start signal is detected, it indicates that the user starts to play. In order to remind the user of the playing rhythm, the beat audio is played, and the playing duration of this time is counted. The playing duration refers to the duration of starting to play the target music score. Based on the target quantity of beats and the playing duration, the part of the target music score currently being played, i.e., the target part, may be determined. In order to remind the user of the position that should currently be played, the target part is marked with a reminder note. The specific manner of marking the reminder note is not limited, such as colored note. Furthermore, the user can select to play a whole content of the target music score in the playing for each time or play part of the content of the target music score. Therefore, the target part may be any part of the target music score, or a part within a certain range of the target music score, which may be specified by the user.

Hereinafter, a computer readable storage medium is provided according to the embodiment of the present disclosure. The computer readable storage medium described below and the method for generating the music score described above may be referred to each other.

A computer readable storage medium is further provided in the present disclosure, where a computer program stores thereon. The computer program, when executed by a processor, implements steps of the method for generating the music score described above.

The computer readable storage medium may include various medium which can store program codes, such as a U disk, a mobile hard disk, a read-only memory (ROM), a random-access memory (RAM), a magnetic disk or an optical disk, etc.

The above embodiments of the present disclosure are described in a progressive manner. Each embodiment is mainly focused on describing differences from other embodiments, and references may be made among these embodiments with respect to the same or similar parts. Since the devices disclosed in the embodiment corresponds to the method disclosed in the embodiment, the description for the device is simple, and reference may be made to description of the method in the embodiment for the relevant parts.

Those skilled in the art may further appreciate that the units and algorithm steps of the examples described in conjunction with the embodiments disclosed herein may be implemented by electronic hardware, computer software, or a combination thereof. In order to clearly illustrate interchangeability between the hardware and the software, the components and steps of each example have been generally described according to their functions in the above description. Whether these functions are executed by means of hardware or software depends on the specific application and design constraints of the technical solution. Those skilled in the art may implement the described function by using different methods for each particular application, but such implementation should not be considered as beyond the scope of the present disclosure.

The steps of the method or algorithm described in conjunction with the embodiments of the present disclosure may be implemented by hardware, a software module executed by a processor, or a combination thereof. The software module may reside in a random access memory (RAM), an internal memory, a read-only memory (ROM), an electrically-programmable ROM, an electrically-erasable programmable ROM, a register, a hard disk, a removable disk, a CD-ROM, or any other forms of storage medium known in the technical field.

Finally, it should also be noted that in this specification, relationship terms such as “first” and “second” etc. are only used to distinguish one entity or operation from another entity or operation, and do not necessarily require or imply that there is any such actual relationship or order between these entities or operations. Moreover, the terms “comprises”, “includes”, or any other variation are intended to cover a non-exclusive inclusion such that a process, method, article, or device comprising a set of elements includes not only those elements but also other elements not expressly listed, and may further include elements inherent to such a process, method, article, or device.

In this specification, specific examples are used to illustrate the principles and implementations of the present disclosure. The above descriptions of embodiments are only used to help understand the methods and essential concept of the present disclosure. Meanwhile, those skilled in the art may make changes in specific implementations and application scenarios based on concepts of the present disclosure. Based on the above description, the content of the specification shall not be understood as a limitation of the present disclosure.

1. A method for generating a music score, comprising:
obtaining a target audio;
generating a chromagram of the target audio corresponding to each of pitch classes;
identifying chords of the target audio based on the chromagram, to obtain chord information;
detecting a mode of the target audio to obtain original mode information;
detecting a rhythm of the target audio to obtain a quantity of beats;
identifying a beat type of each of audio frames of the target audio;
determining a time signature of the target audio based on a correspondence relationship between a beat type and a time signature; and
performing music score rendering based on the chord information, the original mode information, the quantity of beats and the time signature of the target audio, to obtain a target music score.

2. The method for generating the music score according to claim 1, wherein the process of performing music score rendering based on the chord information, the original mode information, the quantity of beats and the time signature of the target audio to obtain the target music score comprises:
determining position information of each word of target lyrics in the target audio, wherein the target lyrics are lyrics corresponding to the target audio;
determining a note type of the each word based on a duration thereof; and
generating a first music score based on the chord information, the original mode information, the quantity of beats and the time signature of the target audio;
performing a marking processing on the first music score by using the target lyrics based on the position information and the note types, to obtain the target music score.

3. The method for generating the music score according to claim 1, wherein the process of performing music score rendering based on the chord information, the original mode information, the quantity of beats and the time signature of the target audio to obtain the target music score comprises:
determining fingering charts based on the chord information;
splicing the fingering charts based on the chord information, to obtain a second music score; and
performing a marking processing on the second music score by using the original mode information, the quantity of beats and the time signature of the target audio to obtain the target music score.

4. The method for generating the music score according to claim 1, wherein the process of performing music score rendering based on the chord information, the original mode information, the quantity of beats and the time signature of the target audio to obtain the target music score comprises:
modifying target information based on an obtained modification information for the music score to obtain modified information; wherein the target information is at least one of the original mode information, the chord information, a music score rendering rule and the quantity of beats; and
generating the target music score based on unmodified non-target information and the modified information.

5. The method for generating the music score according to claim 1, wherein the detecting the mode of the target audio to obtain the original mode information comprises:
extracting a note sequence of the target audio;
performing modulo calculations on the note sequence based on a plurality of different tonic parameters, to obtain a plurality of sequences of calculation results;
comparing each of the plurality of sequences of calculation results with major and minor sequences to obtain a quantity of matched notes; and
determining a mode corresponding to the major and minor sequences and the tonic parameter associated with a maximum quantity of matched notes as the original mode information.

6. The method for generating the music score according to claim 1, wherein the detecting the rhythm of the target audio to obtain the quantity of beats comprises:
calculating an energy value of each of audio frames in the target audio;
dividing the target audio into a plurality of intervals;
calculating an average energy value of each interval where the energy values belong to, based on the energy values;
determining that a beat is detected in a case that the energy value is greater than an energy value threshold; wherein the energy value threshold is obtained from multiplying the average energy value by a weight value of each interval, and the weight value is obtained from a variance of the energy values of each interval; and
counting a quantity of beats per minute to obtain the quantity of beats.

7. The method for generating the music score according to claim 1, wherein the detecting the rhythm of the target audio to obtain the quantity of beats comprises:
generating a log-magnitude spectrum corresponding to the target audio;
inputting the log-magnitude spectrum into a trained neural network to obtain a probability value of each of audio frames in the target audio being a beat;
performing an autocorrelation calculation on a sequence of probability value formed by the probability values to obtain autocorrelation parameters; and
determining a maximum autocorrelation parameter within a preset range as the quantity of beats.

8. The method for generating the music score according to claim 1, further comprising:
establishing an audio and music score correspondence relationship between the target audio and the target music score;
storing the target music score and the audio and music score correspondence relationship;
determining, in a case that a request for outputting a music score is detected, whether there is a request music score corresponding to the request for outputting the music score based on audio and music score correspondence relationships; and
outputting the request music score in a case that there is the request music score.

9. The method for generating the music score according to claim 1, further comprising:
determining a beat audio based on a target quantity of beats in the target music score;
playing the beat audio after a start signal is detected, and counting a playing duration;
determining a target part in the target music score based on the target quantity of beats and the playing duration; and
performing a marking processing on the target part with a reminder note.

10. An electronic device, comprising a memory and a processor, wherein
the memory is configured to store a computer program; and
the processor is configured to execute the computer program to implement a method for generating a music score, the method comprises:
obtaining a target audio;
generating a chromagram of the target audio corresponding to each of pitch classes;
identifying chords of the target audio based on the chromagram, to obtain chord information;
detecting a mode of the target audio to obtain original mode information;
detecting a rhythm of the target audio to obtain a quantity of beats;
identifying a beat type of each of audio frames of the target audio;
determining a time signature of the target audio based on a correspondence relationship between a beat type and a time signature; and
performing music score rendering based on the chord information, the original mode information, the quantity of beats and the time signature of the target audio, to obtain a target music score.

11. A computer readable storage medium, storing a computer program, wherein the computer program, when executed by a processor, implements a method for generating a music score, the method comprises:
obtaining a target audio;
generating a chromagram of the target audio corresponding to each of pitch classes;
identifying chords of the target audio based on the chromagram, to obtain chord information;
detecting a mode of the target audio to obtain original mode information;
detecting a rhythm of the target audio to obtain a quantity of beats;
identifying a beat type of each of audio frames of the target audio;
determining a time signature of the target audio based on a correspondence relationship between a beat type and a time signature; and
performing music score rendering based on the chord information, the original mode information, the quantity of beats and the time signature of the target audio, to obtain a target music score.
